(19) United States
(12) Patent Application Publication
(10) Pub. No.: US 2026/0037768 A1
(43) Pub. Date: Feb. 5, 2026

(54) SYSTEM FOR MANAGEMENT AND RETRIEVAL OF LOST ASSETS

(71) Applicant: Andrew Neal, Prescott, AZ (US)

(72) Inventor: Andrew Neal, Prescott, AZ (US)

(21) Appl. No.: 19/289,511

(22) Filed: Aug. 4, 2025

Related U.S. Application Data
(60) Provisional application No. 63/678,765, filed on Aug. 2, 2024.

(51) Int. Cl. G06K 19/077; G06K 7/14; G06K 19/06; G06Q 50/10

(52) U.S. Cl. CPC G06K 19/07758; G06K 7/1417; G06K 19/06037; G06Q 50/10

(57) ABSTRACT

A system that facilitates the efficient and effective process of registering items with tags and the managed process of returning any of those registered items to their owners is provided. The system platform also allows for larger consumers and companies to provide better asset and item management from pre and post sales. The system may include a unique proactive tag creation using unique scannable codes (such as, but not limited to, QR Codes, 2D Codes, and up and coming advanced AI Object orientated identification) and AI powered item/asset and tag registration process. The system may be deployed using a modern multifaceted communication platform.

### CROSS REFERENCE TO RELATED APPLICATION

This application claims priority to U.S. Provisional Patent Application entitled: “SYSTEM FOR MANAGEMENT AND RETRIEVAL OF LOST ASSETS,” serial number 63/678,765, filed Aug. 2, 2024, the disclosure of which is hereby incorporated entirely herein by reference.

### BACKGROUND OF THE INVENTION

### Technical Field

This invention relates generally to a system for retrieval of lost items and more particularly to a unique tagging system for management and retrieval of checked out and lost items/assets for consumers, businesses and organizations.

### State of the Art

The return of lost items that have been found is largely a space that does not have systems for accomplishing the best result of locating owners of lost items and facilitating a return of those lost items. Existing systems operate to put individuals in touch with one another using a web-based database for people to indicate a lost item and others to post a lost item and hopefully put the owner and the finder in connection with each other. These existing systems do not maintain a database of items prior to losing the item and are simply an online exchange for lost and found information.

Accordingly, there is a need for an improved system for management and retrieval of lost items/assets.

### SUMMARY OF THE INVENTION

The present invention relates to a system that facilitates the efficient and effective processes of registering items with tags and returning any lost registered items to their owners. The system platform also allows for larger consumers and companies to provide better asset and item management from pre and post sales.

The system includes a unique proactive tag creation using unique scannable codes (such as, but not limited to, QR Codes, 2D Codes, and up and coming advanced AI Object orientated identification) and AI powered item/asset and tag registration process. The system may be deployed using a modern multifaceted communication platform.

The following terminology is utilized throughout this application:
a. Tag-a uniquely identified object that users attach and register to their items to create assets in the system/application. Users can order tags from our store or create custom ones in System Tag Designer. These tags may be used in a completely digital format, temporary and wearable via bracelets or other medium or mechanism.
b. Item—an object that the user wants to tag and register in the system/app e.g. laptop, bicycle, book, digital medium, etc.
c. Tags get assigned and items get tagged and assets get registered.
d. Asset—an item that has a tag applied and is registered in the system.
e. Register—the act of combining an item with a tag to create an asset within the system/application.
f. Transferring—the act of assigning ownership of an asset to another user in the system.
g. User-either a consumer and/or a designated person associated with a business that uses the system/application.
h. Sponsored Tags-created in the business account or the personal account of the app but sponsored tags are not tied to any account. Instead, sponsored tags are free to claim by any user account.
i. Inventory Assets-created in the business account section of the app and are owned and assigned by the business account only on company assets.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIGS. 1A-1C are images depicting a general method of operation of a system for management and retrieval of lost items/assets, according to an embodiment;

FIG. 2 is a user interface for signing in or creating an account for using a system for management and retrieval of lost items/assets, according to an embodiment;

FIG. 3 is a user interface for creating an account for a system for management and retrieval of lost items/assets, according to an embodiment;

FIG. 4 is another user interface during the creation of an account for a system for management and retrieval of lost items/assets, according to an embodiment;

FIG. 5 is a user interface of a system for management and retrieval of lost items/assets, according to an embodiment;

FIG. 6 is a profile user interface of a system for management and retrieval of lost items/assets, according to an embodiment;

FIG. 7 is a settings user interface of a system for management and retrieval of lost items/assets, according to an embodiment;

FIG. 8 is an orders user interface of a system for management and retrieval of lost items/assets, according to an embodiment;

FIG. 9 is a user interface for the legal terms and agreements of a system for management and retrieval of lost items/assets, according to an embodiment;

FIG. 10 is an asset details user interface of a found asset using a system for management and retrieval of lost items/assets, according to an embodiment;

FIG. 11 is a messaging system utilized in the return of assets of a system for management and retrieval of lost items/assets, according to an embodiment;

FIG. 12 is an asset details user interface of a lost asset using a system for management and retrieval of lost items/assets, according to an embodiment;

FIG. 13 is a messaging system utilized when seeking the return of a lost asset using a system for management and retrieval of lost items/assets, according to an embodiment;

FIG. 14 is an active asset user interface of a system for management and retrieval of lost items/assets, according to an embodiment;

FIG. 15 is a user interface where the user can edit the details of an active asset of a system for management and retrieval of lost items/assets, according to an embodiment;

FIG. 16 is a my assets user interface of a system for management and retrieval of lost items/assets, according to an embodiment;

FIG. 17 is a new asset user interface of a system for management and retrieval of lost items/assets, according to an embodiment;

FIG. 18 is a screen of a filled out new asset user interface of a system for management and retrieval of lost items/assets, according to an embodiment;

FIG. 19 is an asset preview user interface of a system for management and retrieval of lost items/assets, according to an embodiment;

FIG. 20 is an unassigned tag user interface when an unregistered tag is scanned using a system for management and retrieval of lost items/assets, according to an embodiment;

FIG. 21 is an asset details user interface when scanning a tag on an asset belonging to another user using a system for management and retrieval of lost items/assets, according to an embodiment;

FIG. 22 is a messaging user interface accessible after scanning a tag on an asset belonging to another user using a system for management and retrieval of lost items/assets, according to an embodiment;

FIG. 23 is a user interface for entering contact information for contacting the owner the lost asset using a system for management and retrieval of lost items/assets, according to an embodiment; and

FIG. 24 is a notification interface when sending a message after scanning the tag of a lost asset and sending a message that is directed to the owner of the lost asset using a system for management and retrieval of lost items/assets, according to an embodiment.

### DETAILED DESCRIPTION OF EMBODIMENTS OF THE INVENTION

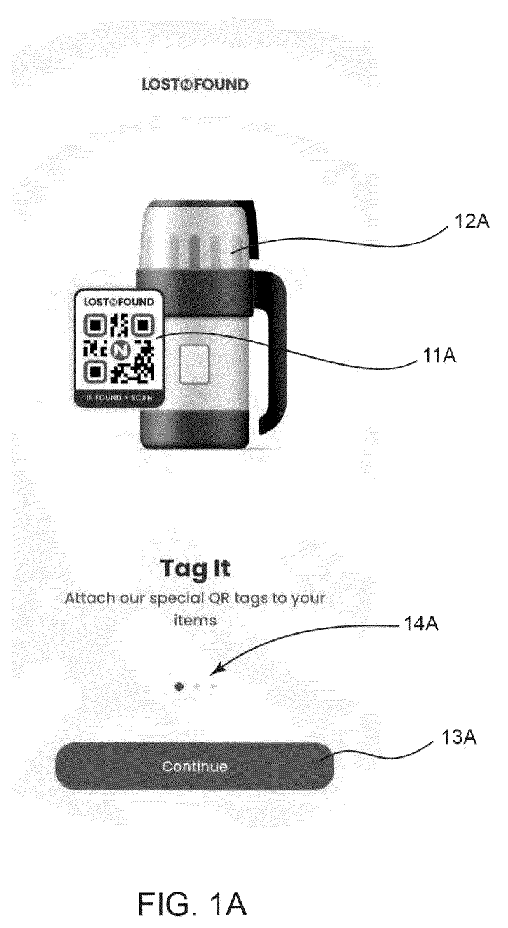

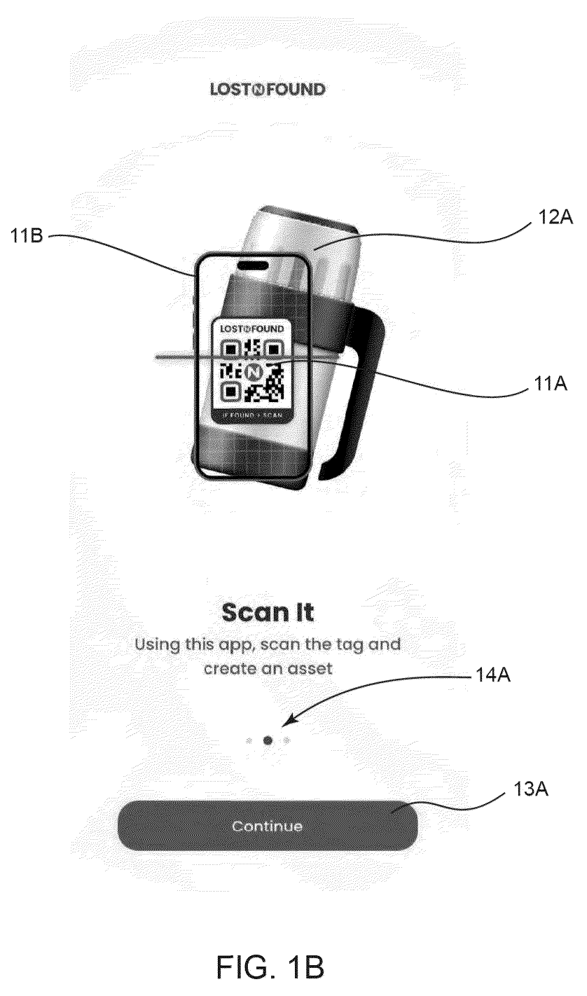

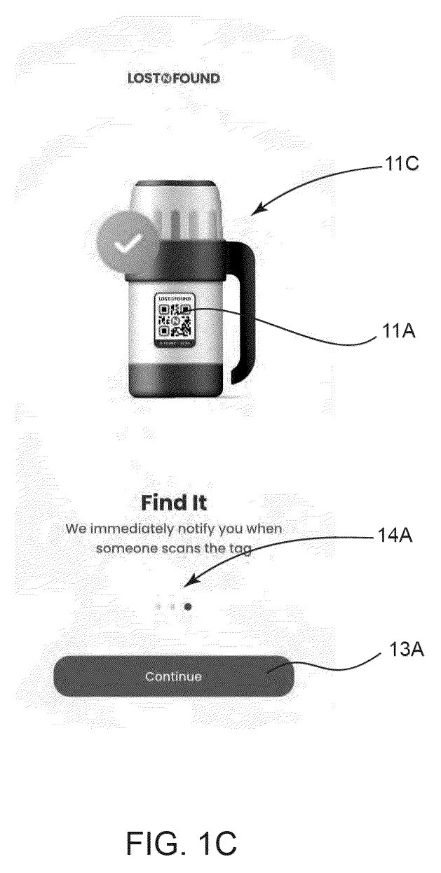

As discussed above, embodiments of the present invention relate to a system for management and retrieval of lost items/assets. A general operation of the system is depicted in FIGS. 1A-1C. Referring to FIG. 1A, the instruction of attaching a tag 11A to an item 12A is shown. The user may press the continue button 13A or swipe 14A to move on to the next screen. Referring to FIG. 1B, a user may use a camera on a user computing device 11B to scan the tag 11A and register the item 12A as an asset. The user may press the “continue” button 13A to move onto the next screen or swipe 14A to move on to the next screen or a previous screen. Referring to FIG. 1C, another person (another app user or an app non-user) may scan the tag 11A of the asset 11C that has been lost, and the system will notify the owner of the asset 11C and facilitate the return of the asset 11C to the owner. The user may press the continue button 13A to move on or swipe 14A to view the previous screens shown in FIGS. 1A and 1B.

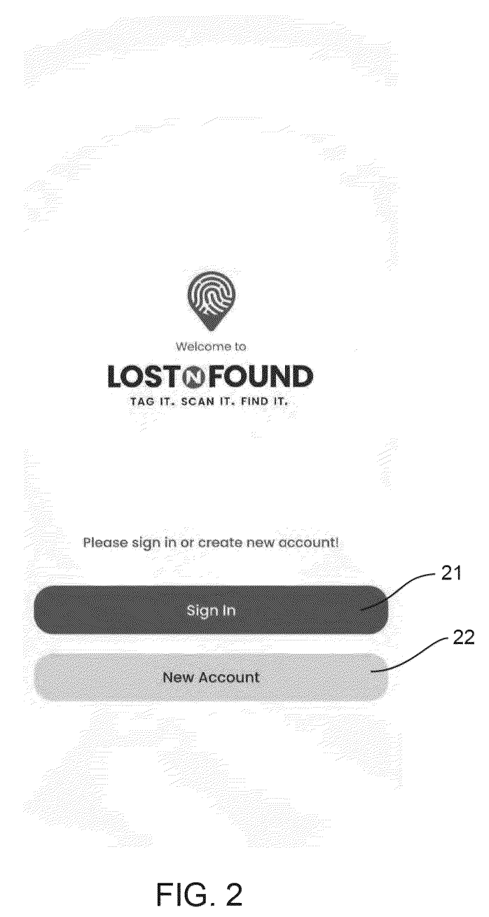

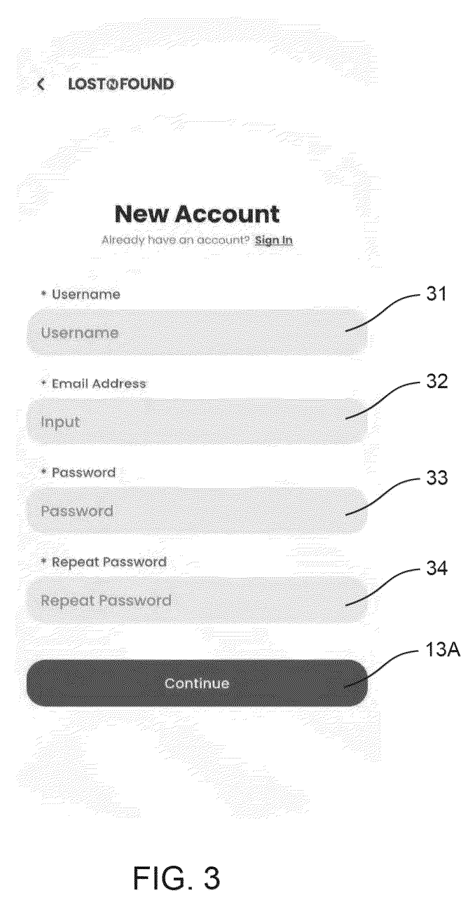

In operation, the system may include an authentication and onboarding process for each user, including an individual consumer, a business or an organization. Referring to FIG. 2, a user may have the option to select a sign in button 21 or to create an account by selecting a new account button 22. If the user selects to sign in using the sign in button 21, the user may be able to sign in securely. If a password is forgotten, users may be able to recover their password from the sign in screen. If a user wishes to create a new account, new users may have the option to create an account, as shown in FIG. 3, providing necessary information, such as, but not limited to Username 31, Email Address 32, Create Password 33, Repeat Password 34, and Agreement with Terms of Service. The user may then select the continue button 13A to move on. If the user is a business, the user goes through standard onboarding to create a personal account and then the user can create a business account linked to the user from his or her account or link himself or herself to an existing business account. If a business option is selected, the system creates two accounts in the background. One is a personal account for the actual user and the other one is a business account that is linked to that personal account as its administrator.

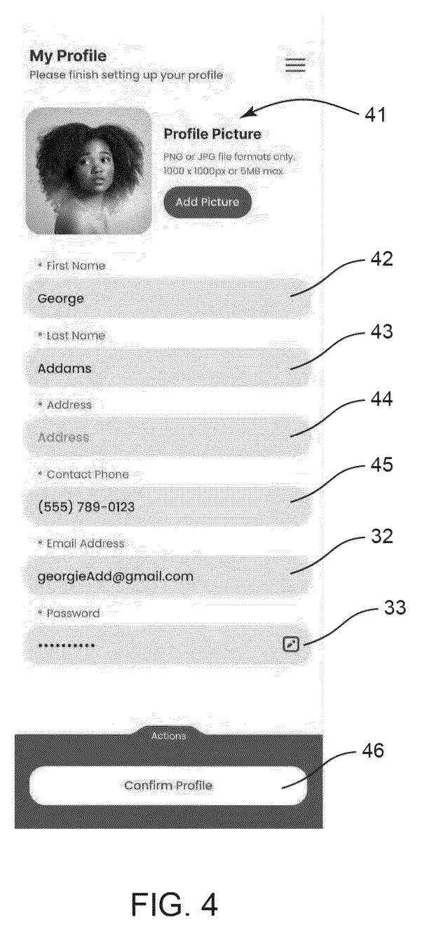

Upon first login, users may be guided through an onboarding process to familiarize them with the app's features and functionality. This consists of 3-5 screens with the continue button 13A and/or swiping 14A to see the next or the previous screen, shown in FIGS. 1A-1C and 4. This onboarding process includes briefly showing a high level of how the system works as depicted in FIGS. 1A-1C and then the system may require additional information for both the personal accounts and the business accounts as depicted in the profile user interface shown in FIG. 4. For example, and without limitation, the additional personal information may include adding a Profile Picture 41 (mandatory), First Name 42 (mandatory), Last Name 43 (mandatory), Address 44 (optional), Contact Phone 45 (optional), and Date of Birth (optional). The user may then save the additional information by selecting the Confirm Profile button 46. Additionally, for example and without limitation, the additional business information (not shown) may include Business Name (mandatory), Logo Upload (mandatory), About Us (mandatory), Full Address (optional), Website URL (optional), Contact phone (mandatory), Contact email (optional, prepopulated but it doesn't have to be the same).

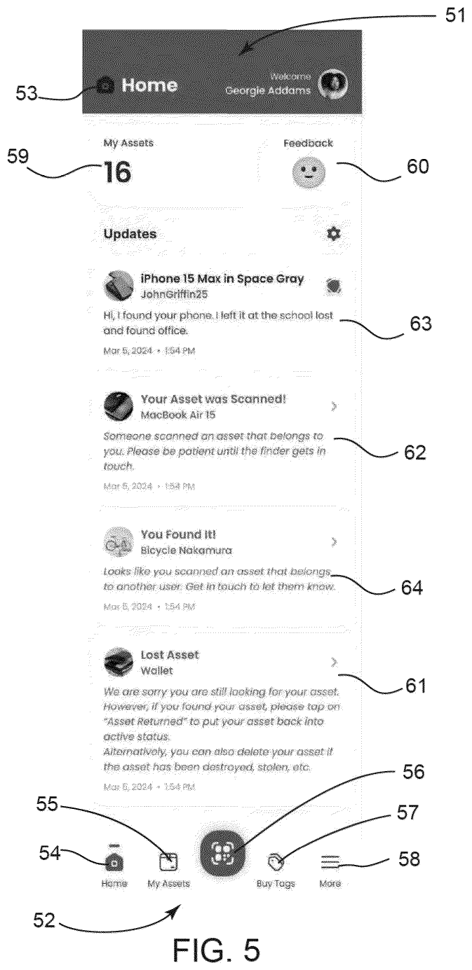

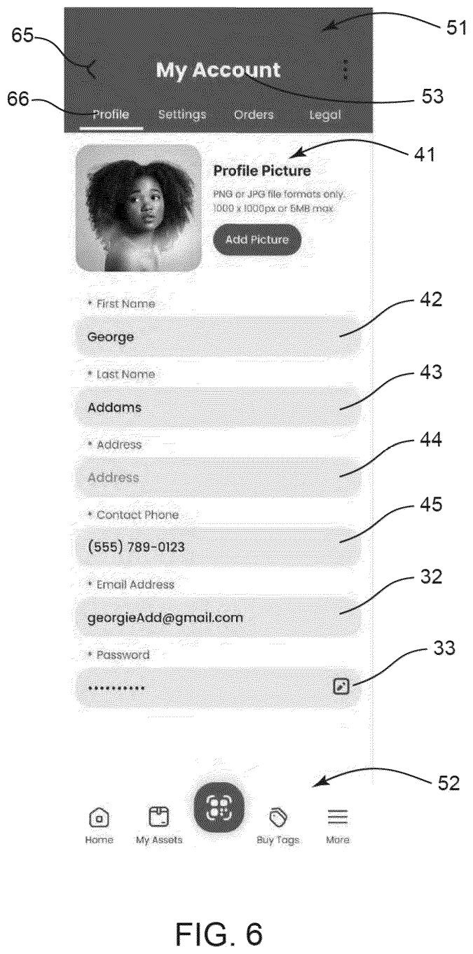

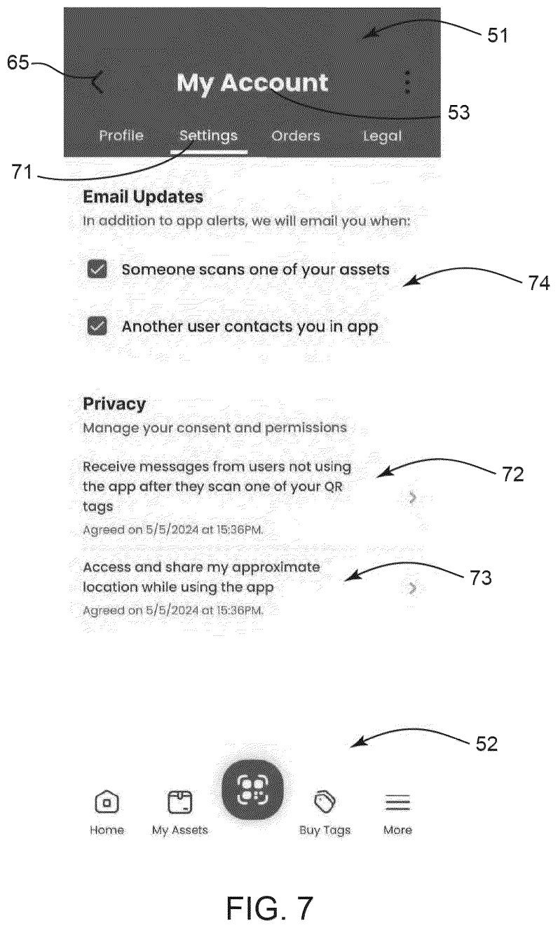

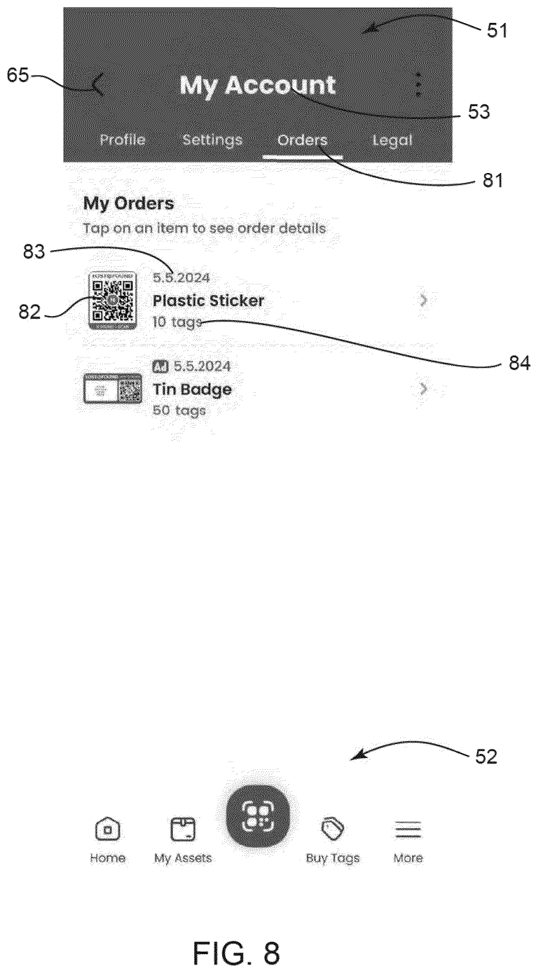

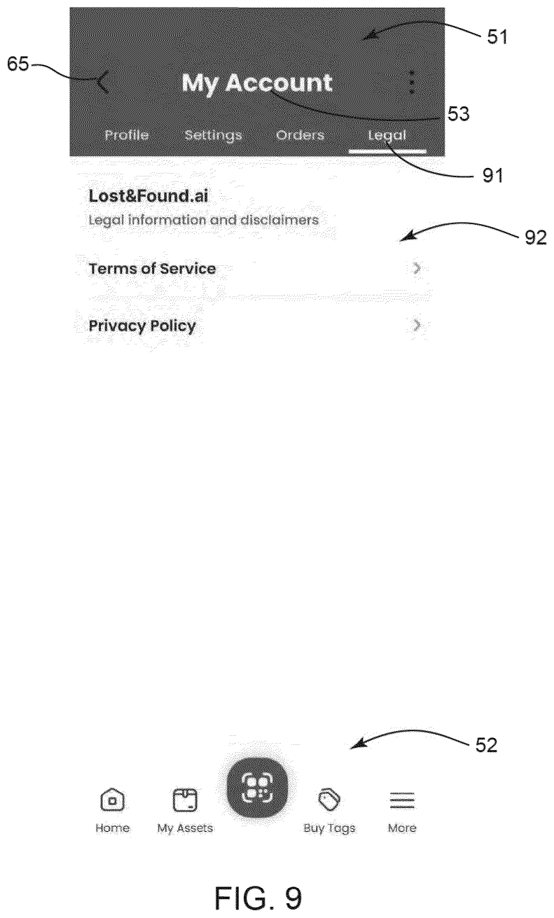

Once a user logins, the system, shown as a mobile application (“app”) may follow a navigation template on every screen. An example may be seen in FIG. 5. The navigation template consists of the header 51 and bottom navigation bar 52. The header 51 may contain feature such as, but not limited to, a Page title 53 and a Back button 65 (see FIG. 6). The bottom navigation bar 52 may contain quick links such as, but not limited to, Home 54, My Assets 55, Tag Scanner 56, Buy Tags 57, and a More button 58 that may include a list of additional features such as My Account, Contact Us, Send Feedback, Help & FAQ, Light/Dark Mode, Log Out, Business/Personal Switch, and the like. An example of different My Account user interfaces accessed using the More button 58 can be seen in FIGS. 6-9. Referring to FIG. 6, a screen under the Profile tab 66 is shown that allows a user to view and update profile information. Referring to FIG. 7, a screen under the Settings tab 71 is shown that allows a user to view and update settings including, but not limited to, consent to receiving messages from other users outside the app 72, the ability to control location sharing permissions 73, and email updates 74. Referring to FIG. 8, a screen under the Orders tab 81 is shown that allows a user to view and update orders. Referring to FIG. 9, a screen under the Legal tab 91 is shown that allows a user to view legal documents of the system 92. From any of these user interfaces, the user can navigate back with the Back button 65 in the header 51 or to any of the quick links on the bottom navigation bar 52.

Referring to FIG. 5, a home screen is a dashboard from which users can access all features of the app. These are the features that the home screen may display excluding what is shown in the navigation bar on the bottom:
a. Statistics on assets leading to My Assets 59
b. Statistics on tags leading to My Tags
c. Send Feedback 60
d. User Groups (each user group gets a card on the home screen)
e. Linked Business Accounts (each gets a card on the home screen)
f. Cards:
   i. Order-in-progress-opens “confirm you received tags” popup
   ii. System notifications:
      1. Advertisements from the system to buy tags
      2. Notifications from the system
      3. Tags are about to expire
   iii. Lost Asset 61
   iv. Asset Scanned 62
   v. Asset Found (with message) 63
   vi. You found an asset 64
   vii. Transfer Request

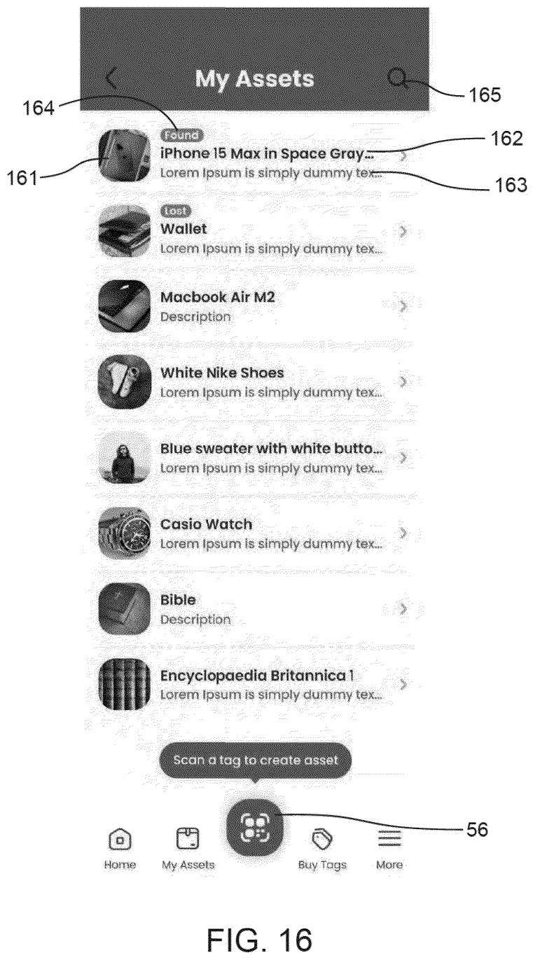

A user's assets may be depicted in the My Assets user interface shown in FIG. 16. Users may be able to view a list of their registered assets. Each asset in a list may display:
a. Primary image 161
b. Asset Title 162
c. Description 163
d. Status 164

Users may be able to use a search option 165 for specific assets.

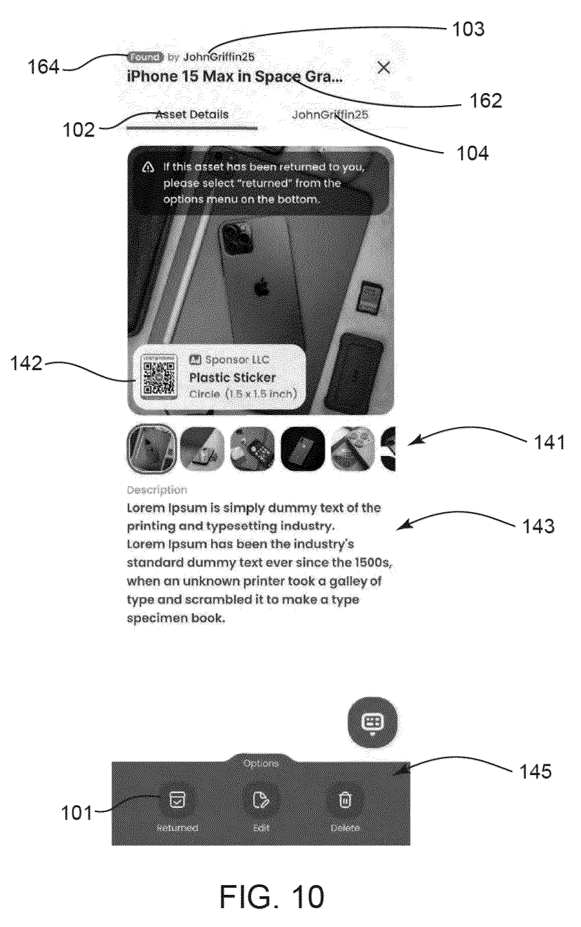

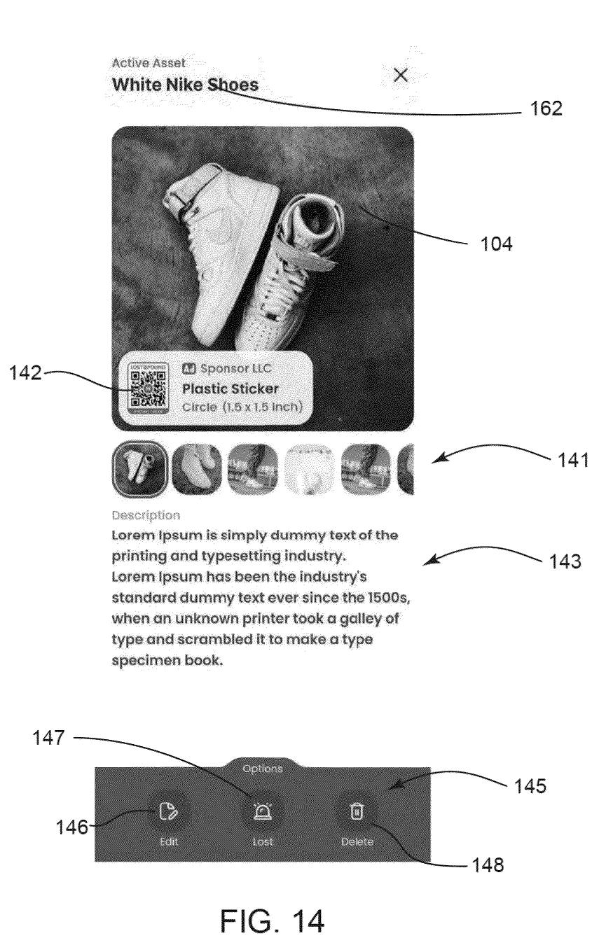

Tapping on an item opens an asset popup showing more details, as shown in FIG. 14:
a. Image gallery 141
b. Assigned Tag with its information 142
c. Full description 143
d. Full title 162
e. Additional information (name of owner)
f. Asset options 145 (depending on the status of the asset):
   i. Edit icon 146
   ii. Lost icon 147
   iii. Delete icon 148
   iv. Transfer icon
   v. Returned icon 101 (see FIG. 10)

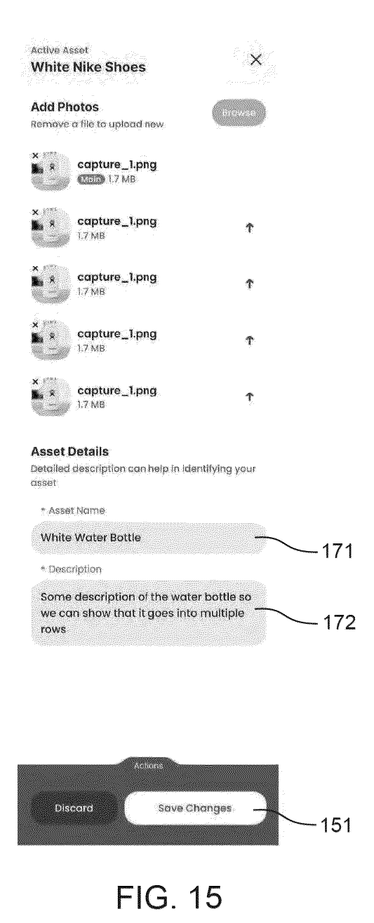

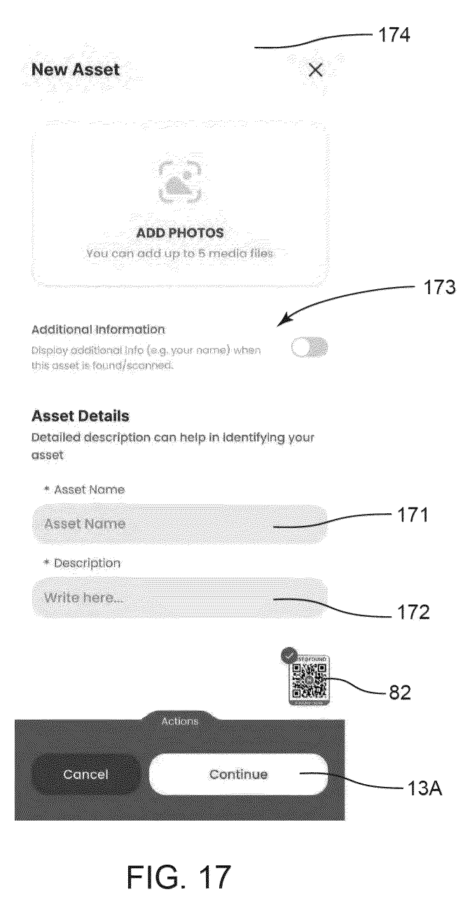

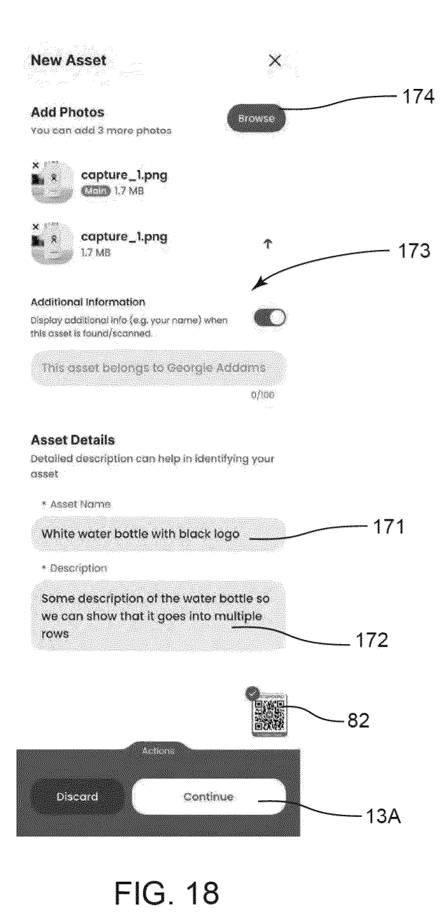

Selecting an asset to edit is depicted in FIG. 15. The screen is like the “New Asset” screen (see FIGS. 17 and 18) with all the fields filled out where users can then modify asset details. The only difference is that there is a Save Changes button 151 rather than a Continue button.

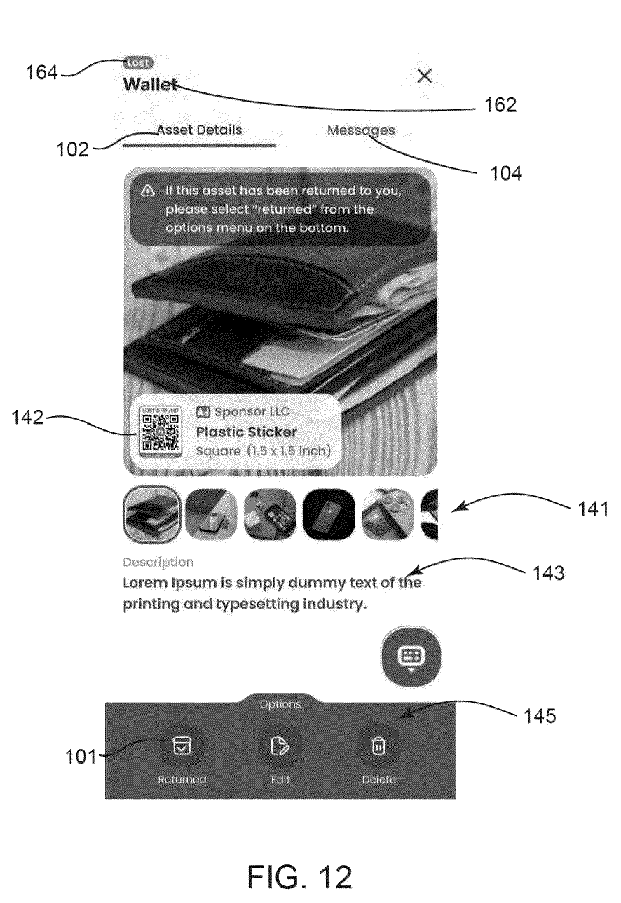

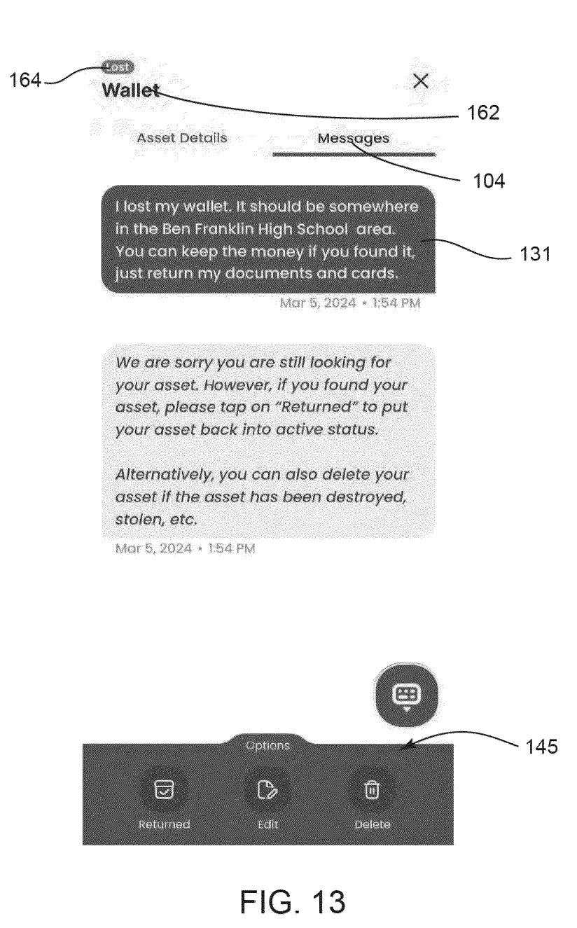

When an asset is lost, the system brings up a popup to confirm. After confirmation, as shown in FIGS. 12-13, the asset changes status 164 to “lost” and a messaging tab 104 allows the users the ability to enter a message to potential finders 131. FIG. 12 displays an example of the information shown under the asset details tab 102 for a lost asset. FIG. 13 displays a user interface example for entering the message to potential finders 131 using the messaging tab 104. Also, the Lost Asset 61 card may appear on the home screen (see FIG. 5).

When an asset is to be transferred, the system brings up a popup with information text about the transferring process. The receiver needs to scan the asset first and then request the transfer. Then, an owner needs to confirm it on his or her side.

When an asset is to be deleted, the system brings up a popup to confirm. Once confirmed, the asset is removed from the app and the assigned tag changes status to “inactive”.

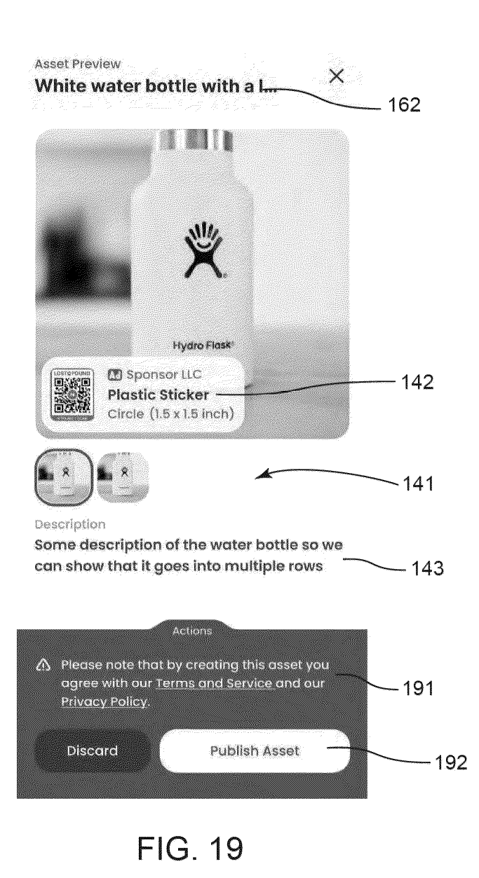

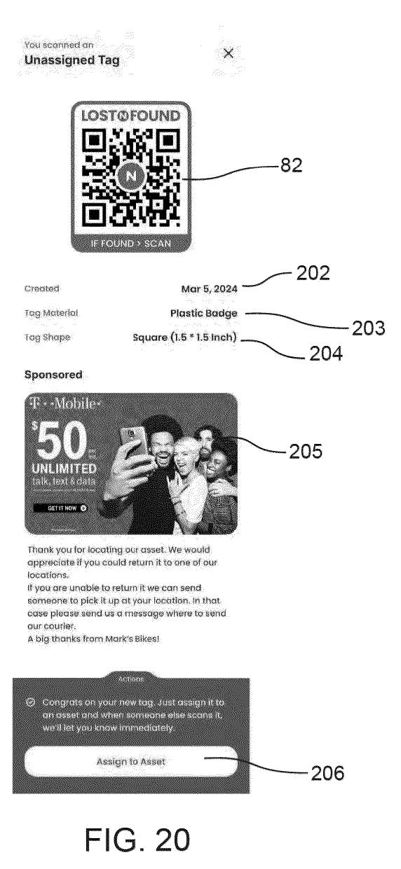

Referring to FIGS. 16-20, users can create new assets when they use the tag scanner 56 (see FIG. 16) to scan an unassigned tag. FIG. 20 displays the user interface when a user scans an unassigned tag. The user interface may include, but is not limited to, information such as a scanned tag preview 82, date created 202, tag material 203, tag shape 204, advertisements 205 (if applicable), and an assign to asset button 206. A “New Asset” screen, shown in FIG. 17, is a data collection form with following inputs:
a. Asset Name box 171 (max 100 characters)
b. Asset description box 172 (max 500 characters)
c. Additional Information 173 (optional)
d. Asset images upload 174 (max 5 images uploaded from phone or directly from camera, ability to select primary image)
e. Scanned Tag Preview 82
f. Continue button 13A
   FIG. 18 displays a user interface example of a filled out new asset screen. After clicking on the continue button 13A to move onto the next screen, the user sees a preview of the asset with all the information entered (see FIG. 19), a disclaimer message 191 and a publish asset button 192. When confirmed, the user sees a success popup and is returned to My Assets screen with a new asset on top of the list.

Users may have a place where they can view and manage all the tag collections and single tags associated with their profile, as shown in FIG. 16. Items in this list are either collections that the user created or purchased, or single tags that the user received from other users. Each of these list items will be managed through options. Collections cannot be opened to see the tags inside because they will all be visually the same. The system may include a search option 165 if the user wants to quickly find the tag or tag collection.

With Tag Collections, users may be able to view a list of their tag collections they either bought in our store or created in tag designer. Each tag collection displays:
a. Tag/template preview (image)
b. Non-Sponsored/Sponsored
c. Not Expired/Expired
d. Total number of tags
e. Number of Tags Assigned/Unassigned
f. Date created
g. Date of Expiry
h. Options:
   i. How to assign (for unassigned-opens up an info popup on how to assign)
   ii. Order from same Template
   iii. View Order Details
   iv. Delete Collection from App (If no tags are assigned)
   v. Extend Expiration Date (for certain types of tags)

Users may be able to view single tags that are associated with their account, but they did not create the tags themselves. Examples would be sponsored tags that were given to them by some company or airline for free as a part of a promotional campaign; or inventory assets that the user is renting from a business (“Out” Status on the business account and “temporary” status on the personal account).

There may be different tag types, such as, but not limited to, personal tags, sponsored tags and business tags. Personal tags are not tied to an account because they might be given as a gift. Personal tags are customized tags that people order from the app and design using the tag designer on the personal account of the app only. The only trace to the account is the order details for respective tag collection. Sponsored tags may be given to other accounts because they are not tied to an account. Standard tags that people buy in our store with our logo on them are also sponsored tags (the system may be the sponsor). Sponsored tags can be created using tag designers in both the personal accounts and the business accounts of the app because the only trace to the account is the order details for that collection. Sponsored tags can also include advertisements. These tags would also be more expensive to order because they can advertise. These tags can be used by any personal account or business account by just scanning the tag and claiming it by tagging an asset with it. Business tags can only be tagged using the business account that was used to order them. Business tags are customized tags that companies order from the app using the tag designer or directly from us. Business tags can also include advertisements.

For other users to create and manage (mark as lost or found) assets with the business tags, the business account owner needs to create a user group where each of the users has permission to assign these tags to company assets. An example would be workers joining the group so they could tag cars on behalf of a rental car company they work for. These tags would be used for inventory tracking (inventory assets). Because inventory assets tagged with business tags may be loaned out, the status of inventory assets owned by a business may display the additional status labels of “out” and “in.” The inventory asset may be labeled as “out” when a client has borrowed or rented the inventory asset. The inventory asset may be labeled as “in” when the inventory asset is in the company's possession.

There are various tag options. The options include:
a. Delete Tags—Deleting tags from accounts is not directly possible. Upon expiration the tag or tag collection would go into an “inactive” status. When a tagged asset is deleted, the tag goes into an “inactive” status.
b. Assign to Item—This option opens a popup that explains that you need to scan the tag first and then create an asset in the app.
c. Tag Expiration—Each tag created in our system gets a default expiration date. There will be extendable and one-time tags in our system. Users need to be notified of that when selecting templates. Users may be notified multiple times prior to tag expiration with instructions on how to proceed.
d. Extendable Tags—Extendable Tags have a custom set expiration date that can also be extended before expiration for a fee or as a premium subscription feature (such as lanyards, keychains). When ordering these tags, users can select a desired expiration period (in checkout) for collections where shorter periods would be more affordable, but we would give discounts on longer periods.
e. One-time Tags—Are tags that have a fixed expiration date which cannot be changed (such as stickers).
f. Repeat Order—This option opens the order summary screen with exact previous order information for that collection:
   i. Selected Template and Description
   ii. Tag Preview Image
   iii. Tag Expiration Date (and selection if extendable)
   iv. Advertisement settings (if applicable)
   v. Number of tags (adjustable)
   vi. Price per tag and total

Additionally, there may be an edit option that would take the user through the tag designer process with all the details pre-populated and then he can modify what he likes along the way. This will modify the order if he wants to change the advertisements or anything else. Changing a template resets the designer since the template affects every step.

Using a tag designer of a system opens a new screen and is used to design new tags. There's a minimum of 10 tags per custom collection and users need to know this before they start designing along with information on how the tag designer works. When selecting a template, users need to be told what the template is, what the material is, the shape, if expiration is customizable, the price, etc. A tag will contain either an uploaded artwork or an AI generated artwork along with the automatically generated code (QR code may be the default code type) placed on top of it where a user can drag the code onto predetermined positions on the grid for that template. The size of the code is fixed and determined by the tag template.

There are tags that also contain an additional area for a logo/image or a text block. The templates that have those options would use the same template and the user can decide what they want in there (logo/image or a name). If they select a name, we give them the input option and they can type it in. If they select the logo option, we give them a file upload so they can upload the logo. The system may give guidelines for logo upload in terms of size, dimensions and the file format we accept. Logo would essentially go through the same process as the custom tag artwork when it is uploaded. By default, an empty tag template with a QR code in default position is displayed.

There may be an artwork archive showing everything user generated or uploaded in the past to make it easier for users to stay consistent. This will also save resources on the system side by reducing unnecessary artwork generation. The system may also display previous orders (if any) so users can repeat their previous orders from the tag designer.

The tag designer may include an autosave feature. The progress is automatically saved to the user's account and if the user leaves the tag designer, a small notification will appear on the “buy tags” icon 57 in the bottom navigation bar 52. When the user clicks on the “buy tags” icon 57, they can pick up where he left off. There may also be an option to restart the process or go to the store to order stock tags.

The system may include an AI artwork generator. Users may be presented by the system with a prompt input field where they describe the artwork and a button that they click to generate. Users may be presented with multiple options each time they generate the artwork. When users tap on the option, the tag is populated with the artwork.

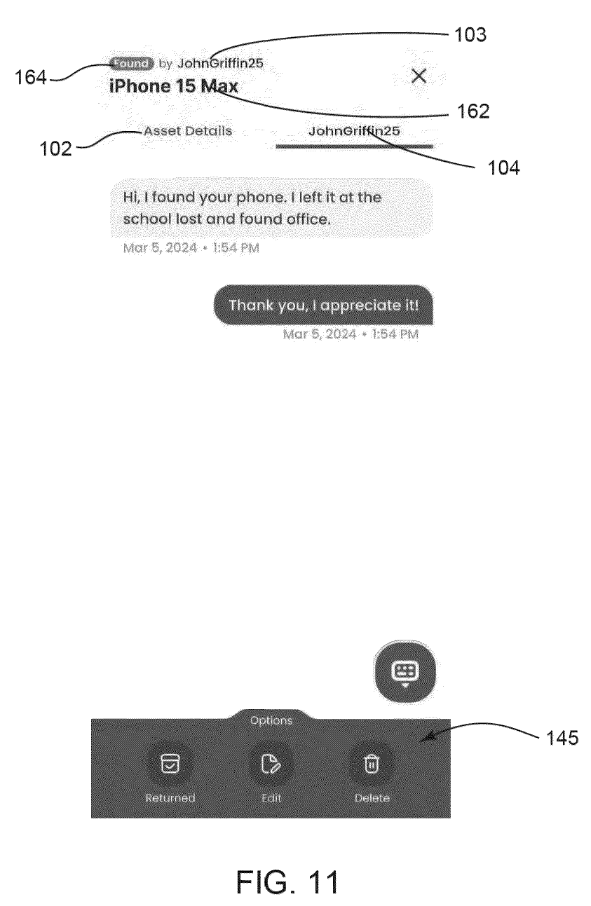

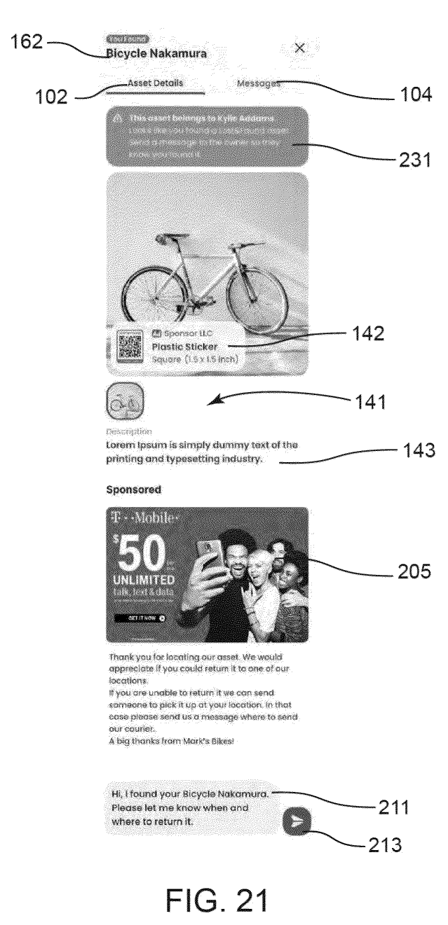

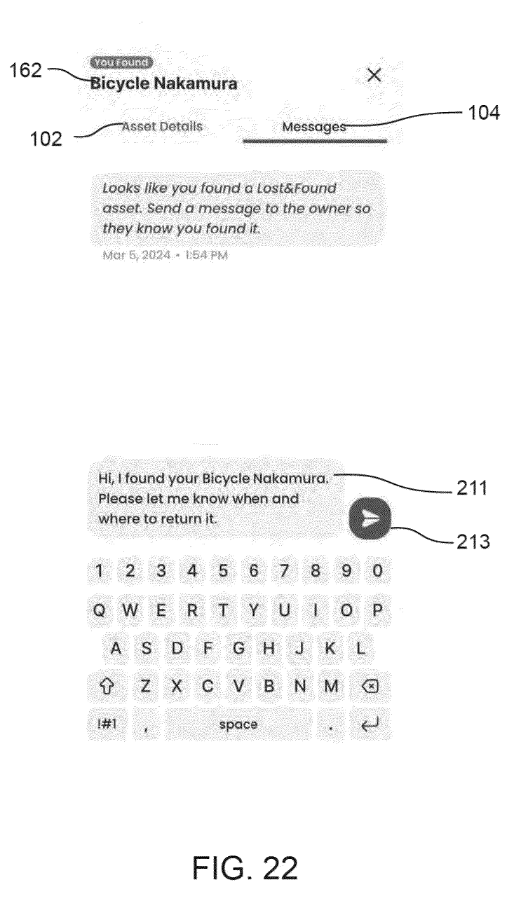

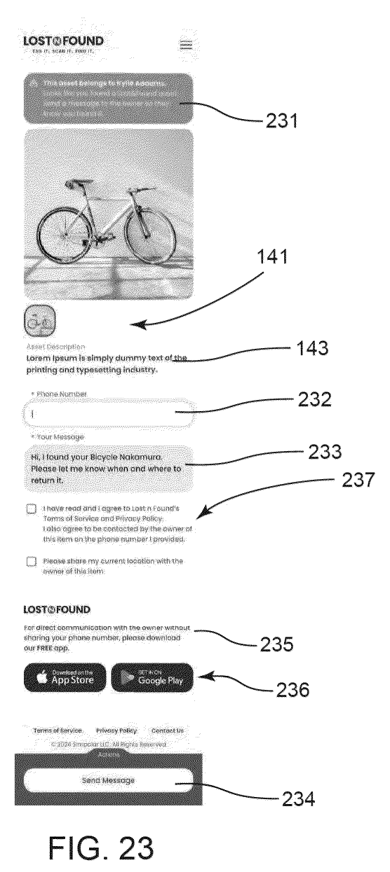

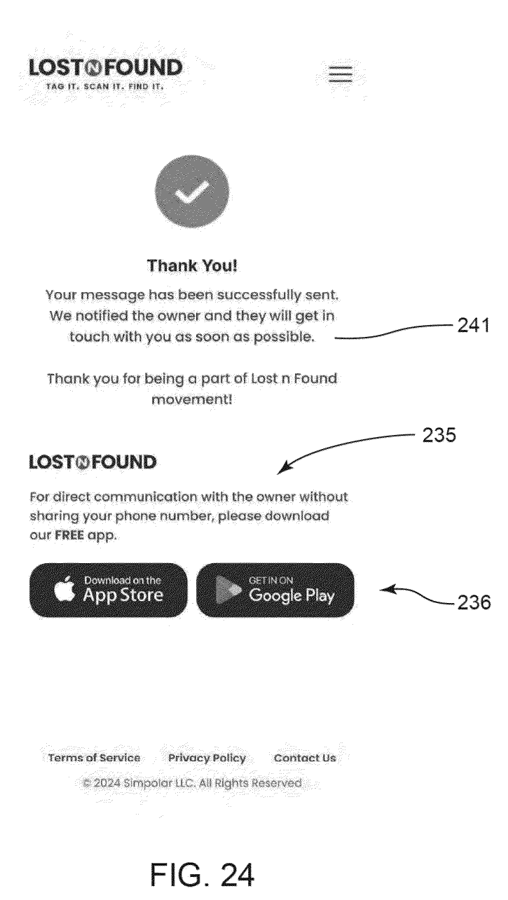

When an asset is found, the system operates to allow the finder to notify the owner of the asset, as shown in FIGS. 10-13 and 21-24. FIG. 10 shows the information under the “Asset Details” tab 102 that is displayed to the user when the asset the user lost has been scanned by a finder 103. The status 164 is shown as “found.” In options 145 there is the returned icon 101 that the user can select after the asset is returned to the user. There is a messaging tab 104 shown in FIG. 10 as well that leads to the user interface shown in FIG. 11. FIG. 11 shows the user interface for the finder 103 messaging the user who owns the asset. FIG. 12 shows the information under the “Asset Details” tab 102 that is displayed to the user when the asset the user lost is still missing. The status 164 is shown as “lost.” There is a messaging tab 104 shown in FIG. 12 that leads to the user interface shown in FIG. 13. FIG. 13 shows the user interface for the user to send a message 131 to be displayed to potential finders. A finder may be a non-app user or an app user. Each instance has its own operation as follows:
a. Non-app User (see FIGS. 23 and 24)—Users who don't have the app installed on their phone use their phones' QR scanner. When the code is recognized, it opens the URL online page displaying:
   i. Asset information 141, 143
   ii. Info box explaining that the owner has been notified of the scan 231
   iii. Input field for phone number 232 (mandatory)
   iv. Message 233 (optional)
   v. “Send Message” button 234
   vi. Info text explaining that they either send their contact info to owner or install the app to contact the owner directly 235
   vii. App store link to download the app 236
   viii. Consent checkboxes 237
   ix. Advertising (if applicable)
   x. A notice signifying the successfully sending of the message to the owner 241
b. App User (see FIGS. 21 and 22)—Users that are using the app can also access the tag scanner 56 from the bottom navigation bar 52. If they use their phone scanner, the app should pick up on that automatically and redirect to app. When an active code is recognized, the app displays a screen containing:
   i. Share geolocation popup (send precise location or track phone location for a certain period)
   ii. Asset information 141, 142, 143
   iii. Info explaining that the owner has been notified of the scan 231
   iv. Messaging option 211
   v. Advertising 205 (if applicable)
   vi. An icon used to send the message 213
   vii. A messages tab 104
c. If the user sends a message, a You found an asset 64 card appears on the home screen (see FIG. 5) containing:
   i. Asset information
   ii. Timestamp
   iii. “Dismiss” button
   iv. Close button

The owner's interaction with the system operates in couple of ways when an asset is found, such as a soft impression and a hard impression. These operate as follows:
a. Soft Impression-When owner's asset has been found and the code scanned, he immediately receives a soft impression popup in the app (if currently using the app) showing the following info:
   i. Asset information
   ii. Timestamp
   iii. Returned icon 101
   iv. Close button
b. Hard Impression—When owner's assets have been code scanned and finder engages by sharing his contact information and geolocation, the owner immediately receives a hard impression popup in the app showing the following info:
   i. Asset information
   ii. Geolocation of the Finder (if shared)
   iii. Timestamp
   iv. Finder Information
   v. Message (if applicable)
   vi. Returned icon 101
   vii. Close button
      The impressions also appear on the home screen as cards, push notification if the user is not in the app at the time, and an email is sent to the user. When the user taps the card on the home screen, the popup appears. Card goes away when the Returned icon 101 has been clicked by the user. That opens a confirmation dialogue just to make sure the user does not hit the returned icon 101 by accident. Home screen keeps history of previously found and lost assets.

The system may include a Community Board. This feature is provided for users to have a way to report assets as lost or found, either untagged or tagged items for cases where tags fall off, are damaged, not easy to find, have been lost for too long, or users want to boost their chances of someone finding the asset so the user pays an additional fee. In order to operate, users need to enable their location to access the community board, sharing either one time or every time. The community board has a card on the home screen which cannot be removed and shows statistics for user's location radius.

The system may also include a “Lost” Board for users who lost an asset and users who found an asset to post. They each may include the following:
a. Users who lost an asset—In addition to marking items as lost, users have an option to post them on the board as an additional feature that may be an additional fee. The assets stay on the board until they have been marked as returned by the user who lost the asset. A card also appears and stays on the home screen until the user who lost the asset marks the asset as returned or is replaced by a hard impression (when someone scans it and contacts the owner). To report a lost item, users need to either select an existing asset or create a new one. In both cases, once the user clicks on “report lost item” the user needs to:
   i. select an asset that has been lost
   ii. set the date the user last had or saw the asset
   iii. set the location (current or where the user last saw the asset)
b. Users who found an asset—Users who find assets or items that belong to someone else may access the board and browse the posted lost assets and items. The assets are sorted by distance from the user's location. Once the user taps on the item list, they get the same screen as if they scanned the asset. When the user sends a message, the owner gets a hard impression on their home screen and the process is then the same as for the scanned assets. If the user cannot find an asset that they found, they have an option to create and post a found item on the board. This would only happen if the user cannot scan the tag or the item is not tagged.

The system may also include a “Found” Board for users who lost an asset and users who found an asset to post. They each may include the following:
a. Users who lost an asset—They can access the board and browse the posted found items. The users need to enable their location to access the board. Once the users tap on an item list, they get a popup with item details and a way to send a message to the finder. Once the owner sends a message to the finder, they both get a card in their home screen. The card is there until the owner marks the item as returned.
b. Users who found an asset—To report a found item, users need to create a post containing:
   i. Short description of the item
   ii. Date the item was found auto populated to current date
   iii. Location share or select location where the item was found
      The system does not collect pictures here because finders are advised to ask for a description of the item from the users who reach out as verification. When an item is posted on the “found bulletin board” it stays there until it has been marked as returned by the owner or the post expires (30 days).

The system allows users to buy tags. This may occur through an integration with existing shopping applications, such as, but not limited to Shopify Integration. The application does not have a dedicated My Cart section. Instead, the tag designer saves the last order progress until it's either submitted or dismissed by the user. Cart would be a Shopify API integrated so it would take on their interface with our colors and as much as we can customize to look like our app. After the order has been placed, a confirmation is displayed to the user and an Order-in-progress card is displayed on the home screen until tags are delivered. This card would open a popup with more details about the order and status and there would be an option to dismiss the card from the home screen.

Referring to FIGS. 6-8, users can view and edit their account profile, account settings, and orders. The following are examples of each:
a. Profile (FIG. 6)
   i. Username
   ii. Email Address 32
   iii. Profile picture 41
   iv. First Name 42
   v. Last Name 43
   vi. Phone Number 45
   vii. Address 32
   viii. Date of Birth
b. Every item on the list is mandatory and can be edited from the profile. From the personal profile, there should be a link to businesses the user is linked to. Users should also be able to log out and delete their account.
c. Settings (FIG. 7)—Users should be able to control what emails they want to receive 74. Users should be able to control their consent to receiving messages from other users outside the app 72. Users should be able to control location sharing permissions 73. Users should be able to control push notification permissions.
d. Orders (FIG. 8)—Users should have a place where all their previous orders and orders-in-progress are displayed. Each order in the list contains following information:
   i. Order ID
   ii. Tag Preview 82
   iii. Date order was placed 83
   iv. Order status
   v. Price
   vi. Number of items 84
   vii. Clicking on an order opens a popup with details of the order and options to:
      1. Download the receipt/confirmation
      2. Cancel order (if not yet in print)
      3. Contact button that opens a contact form with order ID input already filled out
      4. Repeat the order

A Tag Scanner 56 is accessible on the bottom navigation bar 52 of each screen. What is shown to the user depends on the status of the tag that was scanned. Users should be able to report if what they scanned is not what they see in the app, so any errors in the system are noted.

There are additional business workflows contemplated by the system:
a. Asset Found & Impressions-Business assets can also be reported as lost or found.
b. Sponsored Assets-Since sponsor is not an owner of the asset, users deal with lost and found process just like they do for their personal tags.
c. Inventory Assets
   i. Out Status-Means that the asset has been lent out or rented by a client of the business. If a user borrows an inventory asset, and that user marks the item as “lost” or is found by someone else, that asset is locked on user side and cannot be managed by that user until unlocked.
      1. On the business side, the business account (or group) receives a notification that the asset is reported as lost or found and decides the next step:
         a. Delete the asset
         b. Mark as returned
         c. Post as “Lost” on the global bulletin board
         d. Contact the user (in case the item has been found)
      2. Inventory assets on the business side also gets an additional third tab on top for either “Lost” or “Found” messaging.
      3. When the asset has been returned, the status returns to “Out” status.
      4. If an asset has been scanned (found) by a third party, and the asset was created in a business account with a user group, every member of the group gets a card on their home screen and can respond to messages for that asset.
      5. The asset can also be marked as “Lost” by anyone in the group and the group is notified on the messaging board that the asset is lost, and every member gets a card on their home screen.
      6. The asset can be marked as “In” or “Out” by anyone in the group and the group is notified on the messaging board that the asset is back in either “In” or “Out” status.
      7. Members of the user group can also change the status from “Out” to “In”.
   ii. In Status—This means that the asset is currently in the company's possession.
      1. Assets can be manually put from “In” to “Out” status by members of the user group or when an asset has been scanned and requested by a personal account.
      2. The asset can be marked as “Lost” and if the asset is scanned by a third party, the status of the asset changes to “Found”.
      3. The lost and found processes are the same as for the personal tags.

It is also contemplated that the system will have the ability to designate the Type of Tag—this will be a dynamic lookup field that will pull from Types. Based on the Type of Tag it will drive the options for design:
a. System QR Code Tags-Standard Designer
   i. System BAR Code Tags-Standard Designer with limitations as bar codes may be limited to print type due to horizontal printing i.e. a slim line tag on a golf club.
   ii. System RFI Code Tags—The casing that goes around the tag and will not need to be scanned but recognized with scanner.
   iii. System Air Tags—the casing around the air tag will be branded and will not need to be scanned but recognized Bluetooth GPS locator tech.
b. API Management
   i. Currently the API Endpoints established allow for unique creation of branded tags by template and quantities. These unique tags are created in a secure fashion in prepared for print.
   ii. The printing process then derives the unique tags by various QR Coding/Bar Coding/Other unique identifier to create the actual tag production.
   iii. These tags are then sold either direct to consumers via eCommerce, Wholesale, and or via retail outlets.
   iv. Currently, the API management is not open to manufacturers directly or other outlets, but it is the intention that the system will provide such services in future release and configuration of the system/application.
c. Tag Creation Methodology may include a DM code and QR code.

It is contemplated that the system would have a Virtual Lost N Found. The Virtual Lost N Found would provide a virtual lost and found for personal, private groups, and public locations. These items can either be checked in with an image or a scan of the tag on the item. Items can be tagged inherently or untagged.
a. The same features apply allowing these virtual lost and founds that may or may not have physical locations to meet for drop off or check in or check out items

It is contemplated that digital tags via an API call for Brands would be offered for users that wish to purchase digital tags vs. physical product from us. This platform is “Powered By LNFT.AI,” and the digital tags either produced physically by Lost N Found but powered by Inft.ai to allow for unique interactions after the tags are either scanned or activated using tap to scan technology. Whoever scans the tag is taken to a dynamic web page where the end user who owns the tag can adjust and configure the resulting landing page.

The digital tag integration is offered on some consumer purchased products which gives the user full control over the experience of the tag post being scanned.
a. Some of the types of functionalities include, but are not limited to the list below:
   i. Landing Page
   ii. Social Media Pages
   iii. Share Contact Information
   iv. Tap to Pay—with a loaded digital wallet
   v. Digital Wallet
   vi. Digital Billboards for self-marketing

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A system for facilitating the process of managing and tracking items comprising:
an item;
a tag having a unique identity, wherein the tag is configured to couple to the item;
a server having a memory storing information about a user;
a user computing device having a camera, the user computing device coupled to the server;
an application operating on the user computing device, wherein the application is programmed to:
access the system and connect with the server;
scan the tag through use of the camera of the user computing device;
send user input information about the item after scanning the tag to the server, wherein the scanned tag is associated with the item and the item becomes an asset;
receive input from the user to mark a status of the asset as lost;
scan a code coupled to a lost asset that the user does not own, and send the same to the server, wherein the server notifies an owner of the lost asset when the lost asset's tag is scanned; and
connect the user computing device with a computing device of the owner to facilitate a return of the lost asset.

2. The system of claim 1, wherein the user can link the personal account with a business account.

3. The system of claim 2, wherein the asset registered in the business account can be marked as “in” or “out” when the asset is able to be rented or loaned.

4. The system of claim 1, wherein the application comprises a community board wherein the user may post assets the user finds or loses, wherein the posted assets are missing tags or scanning the tags is not working.

5. The system of claim 1, wherein the tag comprises a System QR Code Tag.

6. The system of claim 1, wherein the tag comprises a System BAR Code Tag.

7. The system of claim 1, wherein the tag comprises a System RFI Coade Tag.

8. The system of claim 1, wherein the tag comprises a System Air Tag or the tag uses an advanced AI object orientated identification.

9. The system of claim 1, wherein the tag comprises an extendable expiration date.

10. The system of claim 1, wherein the tag is a one-time tag without an extendable expiration date.

11. A method of using an application to register and manage items, the method comprising:
using a camera on the user computing device to scan a tag;
using the application to input item information corresponding to the item;
submitting the item information in the application to a server to associate the tag with the item and to register the item as an asset by storing the same on the server;
coupling the tag to the item;
marking a status of the asset as lost using the application when a user has lost the asset; and
notifying the user when the tag coupled to the lost asset is scanned.

12. The method of claim 11, wherein creating the personal account can include a step to link the personal account to a business account.

13. The method of claim 12, wherein loaning or renting assets to an individual is allowed with the business account, wherein assets can be marked as “in” or “out.”.

14. The method of claim 11, wherein scanning the lost asset sends a soft impression popup to an owner of the item.

15. The method of claim 11, wherein scanning of the lost asset may further comprise sharing contact information of a finder to send a hard impression popup to an owner of the item.

16. A method of generating a tag comprising:
accessing a tag design page on an application;
selecting a tag template to use to design the tag;
designing the tag, wherein a user may use images and/or text in the tag design; and
ordering the tags.

17. The method of claim 16, wherein designing tags in a personal account allows a user to design personal tags or sponsored tags, wherein the sponsored tags may contain advertisements.

18. The method of claim 16, wherein designing tags in a business account allows the user to design sponsored tags or business tags, wherein the sponsored tags and the business tags may contain advertisements.

19. The method of claim 16, wherein generating images to use in the tag design may use an AI artwork generator in the application.

20. The method of claim 16, wherein ordering the tags from the application uses an integrated shopping application.
